(19) United States
(12) Patent Application Publication
(10) Pub. No.: US 2024/0405825 A1
(43) Pub. Date: Dec. 5, 2024

(54) TECHNIQUES FOR TRANSMITTING TWO-PART UPLINK CONTROL INFORMATION FOR GROUP-BASED BEAM REPORTING

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/694,289

(22) PCT Filed: Nov. 5, 2021
(86) PCT No.: PCT/CN2021/128881

§ 371 Date: Mar. 21, 2024

(51) Int. Cl. H04B 7/06; H04B 17/318

(52) U.S. Cl. CPC H04B 7/0626; H04B 7/06952; H04B 17/328

(57) ABSTRACT

Various aspects of the present disclosure generally relate to wireless communication. In some aspects, a user equipment (UE) may receive, from a base station associated with multiple transmit-receive points, a plurality of reference signals associated with a plurality of beam groups. The UE may transmit, to the base station, a channel state information (CSI) report that includes a group-based beam report indicating beam measurements associated with the plurality of reference signals, wherein the CSI report includes a first uplink control information (UCI) and a second UCI that is transmitted separately from the first UCI. Numerous other aspects are described.

### FIELD OF THE DISCLOSURE

Aspects of the present disclosure generally relate to wireless communication and to techniques and apparatuses for transmitting two-part uplink control information (UCI) for group-based beam reporting.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station associated with multiple transmit-receive points, a plurality of reference signals associated with a plurality of beam groups; and transmitting, to the base station, a channel state information (CSI) report that includes a group-based beam report indicating beam measurements associated with the plurality of reference signals, wherein the CSI report includes a first uplink control information (UCI) and a second UCI that is transmitted separately from the first UCI.

In some aspects, a method of wireless communication performed by a base station includes transmitting, to a UE, a plurality of reference signals associated with a plurality of beam groups; and receiving, from the UE, a CSI report that includes a group-based beam report indicating beam measurements associated with the plurality of reference signals, wherein the CSI report includes a first UCI and a second UCI that is received separately from the first UCI.

In some aspects, an apparatus for wireless communication at a UE includes a memory and one or more processors, coupled to the memory, configured to: receive, from a base station associated with multiple transmit-receive points, a plurality of reference signals associated with a plurality of beam groups; and transmit, to the base station, a CSI report that includes a group-based beam report indicating beam measurements associated with the plurality of reference signals, wherein the CSI report includes a first UCI and a second UCI that is transmitted separately from the first UCI.

In some aspects, an apparatus for wireless communication at a base station includes a memory and one or more processors, coupled to the memory, configured to: transmit, to a UE, a plurality of reference signals associated with a plurality of beam groups; and receive, from the UE, a CSI report that includes a group-based beam report indicating beam measurements associated with the plurality of reference signals, wherein the CSI report includes a first UCI and a second UCI that is received separately from the first UCI.

In some aspects, a non-transitory computer-readable medium storing a set of instructions for wireless communication includes one or more instructions that, when executed by one or more processors of a UE, cause the UE to: receive, from a base station associated with multiple transmit-receive points, a plurality of reference signals associated with a plurality of beam groups; and transmit, to the base station, a CSI report that includes a group-based beam report indicating beam measurements associated with the plurality of reference signals, the CSI report includes a first UCI and a second UCI that is transmitted separately from the first UCI.

In some aspects, a non-transitory computer-readable medium storing a set of instructions for wireless communication includes one or more instructions that, when executed by one or more processors of a base station, cause the base station to: transmit, to a UE, a plurality of reference signals associated with a plurality of beam groups; and receive, from the UE, a CSI report that includes a group-based beam report indicating beam measurements associated with the plurality of reference signals, the CSI report includes a first UCI and a second UCI that is received separately from the first UCI.

In some aspects, an apparatus for wireless communication includes means for receiving, from a base station associated with multiple transmit-receive points, a plurality of reference signals associated with a plurality of beam groups; and means for transmitting, to the base station, a CSI report that includes a group-based beam report indicating beam measurements associated with the plurality of reference signals, the CSI report includes a first UCI and a second UCI that is transmitted separately from the first UCI.

In some aspects, an apparatus for wireless communication includes means for transmitting, to a UE, a plurality of reference signals associated with a plurality of beam groups; and means for receiving, from the UE, a CSI report that includes a group-based beam report indicating beam measurements associated with the plurality of reference signals, the CSI report includes a first UCI and a second UCI that is received separately from the first UCI.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3-5 are diagrams illustrating examples associated with transmitting two-part uplink control information (UCI) for group-based beam reporting, in accordance with the present disclosure.

FIGS. 6-7 are diagrams illustrating example processes associated with transmitting two-part UCI for group-based beam reporting, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

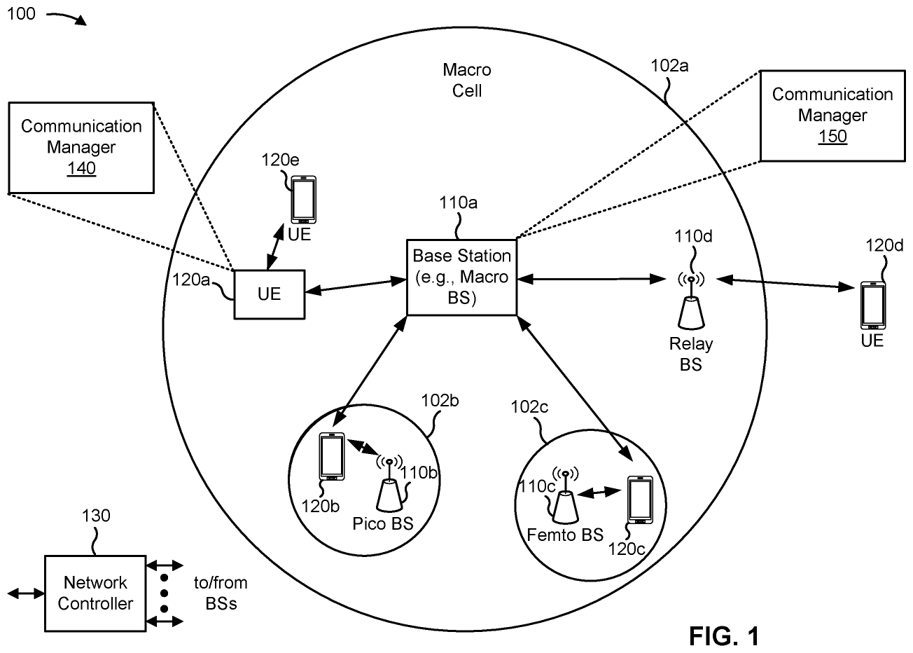

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHz) and FR2 (24.25 GHz-52.6 GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a,

FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a base station associated with multiple transmit-receive points, a plurality of reference signals associated with a plurality of beam groups; and transmit, to the base station, a channel state information (CSI) report that includes a group-based beam report indicating beam measurements associated with the plurality of reference signals, wherein the CSI report includes a first uplink control information (UCI) and a second UCI that is transmitted separately from the first UCI. Additionally, or alternatively, the communication manager 140 may perform one or more other operations described herein.

In some aspects, a base station (e.g., base station 110) may include a communication manager 150. As described in more detail elsewhere herein, the communication manager 150 may transmit, to a UE, a plurality of reference signals associated with a plurality of beam groups; and receive, from the UE, a CSI report that includes a group-based beam report indicating beam measurements associated with the plurality of reference signals, the CSI report includes a first UCI and a second UCI that is received separately from the first UCI. Additionally, or alternatively, the communication manager 150 may perform one or more other operations described herein.

As indicated above, FIG. 1 is provided as an example. Other examples may differ from what is described with regard to FIG. 1.

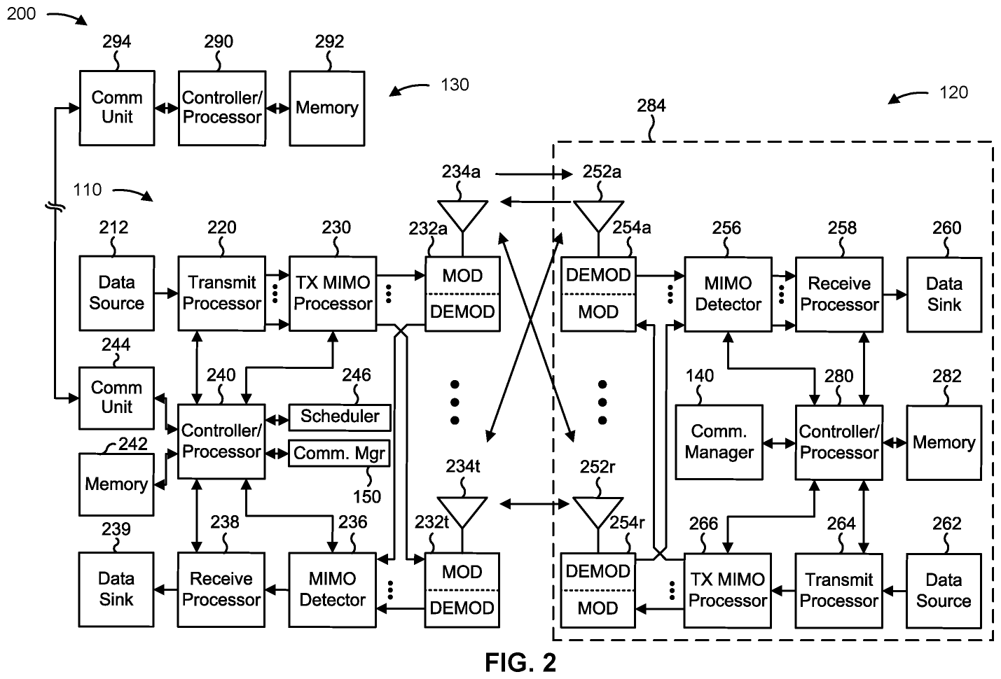

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

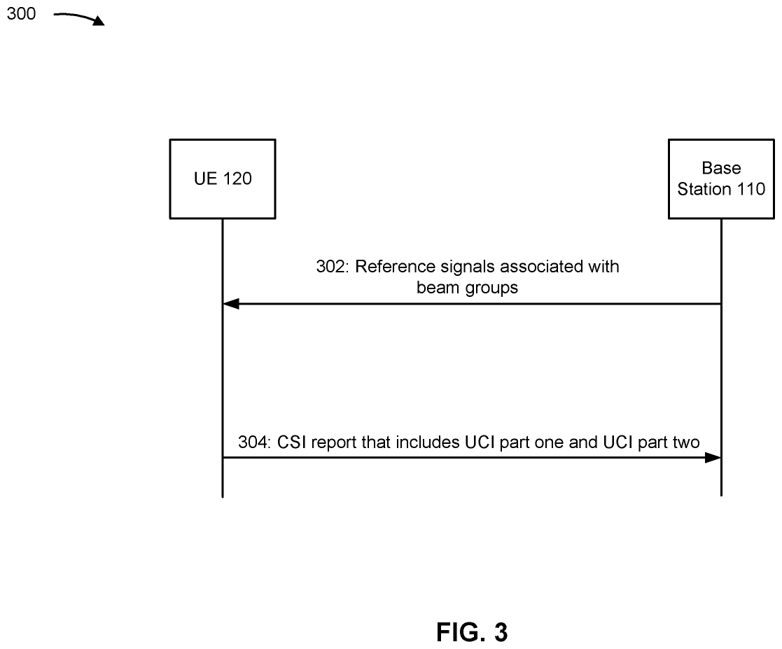

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-9).

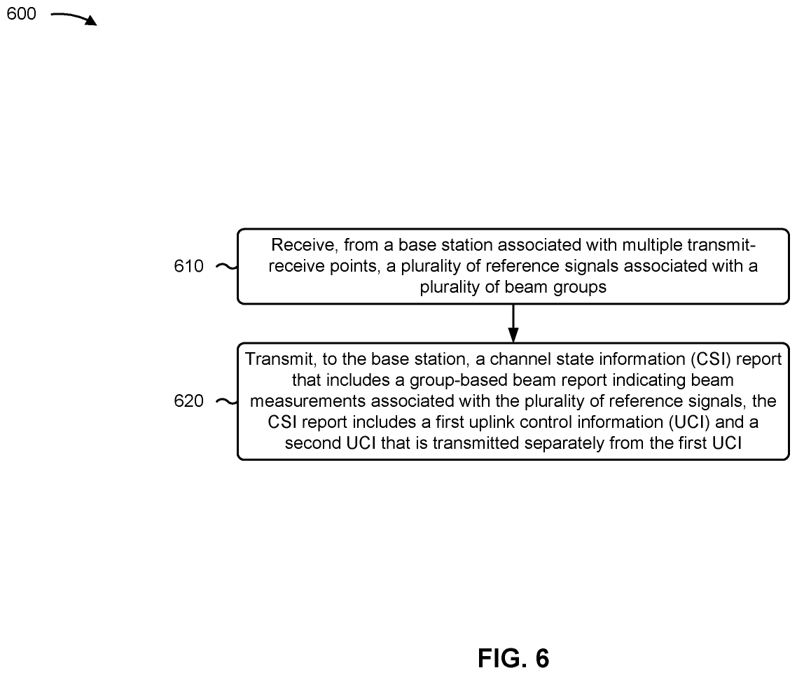

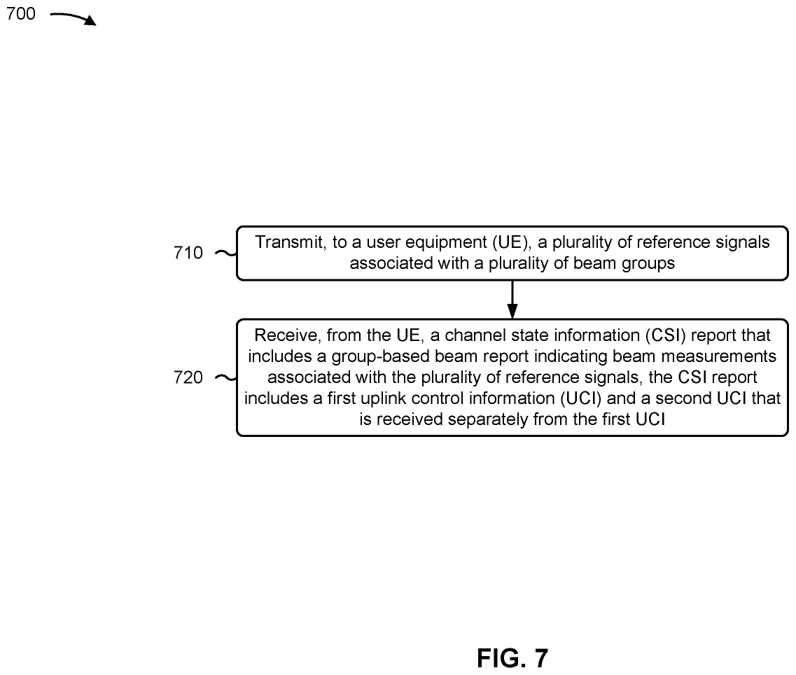

The controller/processor 240 of the base station 110, the controller/processor 280 of the UE 120, and/or any other component(s) of FIG. 2 may perform one or more techniques associated with transmitting two-part UCI for group-based beam reporting, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a base station associated with multiple transmit-receive points, a plurality of reference signals associated with a plurality of beam groups; and/or means for transmitting, to the base station, a CSI report that includes a group-based beam report indicating beam measurements associated with the plurality of reference signals, wherein the CSI report includes a first UCI and a second UCI that is transmitted separately from the first UCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a base station (e.g., base station 110) includes means for transmitting, to a UE, a plurality of reference signals associated with a plurality of beam groups; and/or means for receiving, from the UE, a CSI report that includes a group-based beam report indicating beam measurements associated with the plurality of reference signals, the CSI report includes a first UCI and a second UCI that is received separately from the first UCI. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A UE may perform beam measurements based at least in part on a simultaneous transmission from multiple TRPs. The UE may support a single CSI report to indicate the beam measurements. The CSI report may indicate N beam pairs/groups and M (where M is greater than one) beams per pair/group, and different beams within a pair/group may be received simultaneously. In some cases, M may be equal to two, and N may be equal to or greater than one. For example, N may be equal to one or two, or N may be equal to a value greater than two. The UE may report the beam measurements associated with different Rx beams. The beam measurements may be based at least in part on layer 1 (L1) RSRP measurements and/or L1 signal-to-interference-plus-noise ratio (SINR) measurements.

For beam measurement and reporting, the single CSI report may support a maximum number of beam groups (Nₘₐₓ) based at least in part on a UE capability, where Nₘₐₓ may be equal to 1, 2, 3, or 4. In some cases, when Nₘₐₓ is greater than or equal to two, an uplink control information (UCI) payload reduction may be needed. The single CSI report may correspond to the number of beam groups (N), where a value of N may be configured via radio resource control (RRC) signaling.

A UCI payload for a group-based beam report may be 19 bits. Of the 19 bits, 8 bits (4*2) may be used for two beam indexes, and 11 bits (7+4) may be used for two L1-RSRP or L1-SINR values. The 11 bits may correspond to absolute values and differential values. The UCI payload for an enhanced group-based beam report may be larger than 19 bits. For example, in the UCI payload for the enhanced group-based beam report, up to 8 beam indexes and corresponding L1 metrics may be reported. The UCI payload may be 68 bits, where 32 bits (4*8) may be used for the 8 beam indexes, 1 bit may be used for a channel measurement resource (CMR) set selection for determining a largest RSRP, and 35 bits (7+4*7) may be used for remaining L1 metrics. The 35 bits may correspond to absolute values and differential values.

However, as the maximum number of beam groups for the UCI payload increases, the number of bits needed by the UE to transmit the UCI payload for the enhanced group-based beam report may increase as well. The number of bits needed by the UE to transmit the UCI payload for the enhanced group-based beam report may be relatively large and consume a relatively large amount of network resources. Therefore, transmitting the UCI payload for the enhanced group-based beam report in a more efficient manner is beneficial for reducing a network usage and complexity at the UE.

In various aspects of techniques and apparatuses described herein, a UE may receive, from a base station associated with multiple TRPs, a plurality of reference signals associated with a plurality of beam groups. The UE may transmit, to the base station, a CSI report that includes a group-based beam report indicating beam measurements associated with the plurality of reference signals. The CSI report may include a first UCI and a second UCI that is transmitted separately from the first UCI. In other words, the first UCI and the second UCI may be different UCIs, and the first UCI may be encoded entirely and independently before the second UCI. The first UCI and the second UCI may be transmitted in a single uplink transmission such as in a physical uplink shared channel (PUSCH) or physical uplink control channel (PUCCH) resource, and may be encoded in different parts of the uplink transmission. The CSI report may include two UCI parts (e.g., the first UCI and the second UCI) based at least in part on a maximum number of beam groups configured in a CSI report configuration received from the base station, or based at least in part on a dedicated RRC indication received from the base station. The UE may determine whether the CSI report include two UCI parts (e.g., the first UCI and the second UCI) or not, based at least in part on a maximum number of beam groups configured in a CSI report configuration received from the base station, or based at least in part on a dedicated RRC indication received from the base station. The CSI report with the two UCI parts may be more efficient than transmitting a CSI report with a larger UCI payload, thereby reducing the network usage and complexity at the UE. Further, a larger UCI payload may need to be subjected to a UCI payload reduction, which would negatively impact a performance of the UE.

FIG. 3 is a diagram illustrating an example 300 associated with transmitting two-part UCI for group-based beam reporting, in accordance with the present disclosure. As shown in FIG. 3, example 300 includes communication between a UE (e.g., UE 120) and a base station (e.g., base station 110). In some aspects, the UE and the base station may be included in a wireless network, such as wireless network 100.

As shown by reference number 302, a UE may receive, from a base station associated with multiple TRPs, a plurality of reference signals associated with a plurality of beam groups. The plurality of reference signals may be associated with N beam pairs/groups, with M beams per pair/group. The UE may be capable of receiving the M beams in a pair/group simultaneously.

As shown by reference number 304, the UE may transmit, to the base station, a CSI report that includes a first UCI and a second UCI. The CSI report may be an enhanced group-based beam report indicating beam measurements associated with the plurality of reference signals. The UE may transmit the enhanced group-based beam report in a UCI of two parts, where the UCI may include the first UCI and the second UCI. The first UCI may be different from and transmitted separately from the second UCI.

In some aspects, the CSI report may include the first UCI and the second UCI based at least in part on a maximum number of beam groups configured in a CSI report configuration received from the base station. In some aspects, the CSI report may include the first UCI and the second UCI based at least in part on a dedicated RRC indication received from the base station, where the dedicated RRC indication may indicate a two-part UCI.

In some aspects, the UE may perform the enhanced group-based beam report in the UCI of two parts based at least in part on the maximum number of beam groups configured in the CSI report configuration. For example, when the maximum number of beam groups configured in the CSI report configuration is greater than two, the UE may use the UCI of two parts to transmit the enhanced group-based beam report. Otherwise, the UE may use a single-part UCI to transmit the enhanced group-based beam report. In some aspects, splitting the UCI into two parts when transmitting the enhanced group-based beam report may improve efficiency and a utilization of network resources.

In some aspects, the UE may perform the enhanced group-based beam report in the UCI of two parts based at least in part on the dedicated RRC indication received from the base station. For example, the UE may use the UCI of two parts to transmit the enhanced group-based beam report based at least in part on an indication of an RRC parameter “two-part-UCI”, which may be received from the base station.

In some aspects, the UE may transmit the first UCI before transmitting the second UCI. For example, the UE may encode or transmit the first UCI in an entirety before encoding or transmitting the second UCI. The UE may transmit the UCI of two parts in a PUCCH or in a PUSCH.

In some aspects, the first UCI may indicate a number of beam groups reported in the CSI report, and the second UCI may indicate beam indexes and L1 metrics for reported beam groups. The beam indexes and L1 metrics may include one or more channel state information reference signal (CSI-RS) resource indicators (CRIs), one or more synchronization signal (SS) or physical broadcast channel (PBCH) resource indicators (SSBRIs), a CMR set indicator, an RSRP value, and/or one or more differential RSRP values. The CMR set indicator may indicate the reported strongest reference signal belongs to which CMR set measured for the CSI report.

In some aspects, when the UE reports the UCI of two parts, the first UCI may indicate the number of beam groups actually reported in the CSI report. For example, the CSI report may configure the UE to report up to four beam groups, and the UE may identify and report only two satisfying beam groups. Thus, in this example, the UE may indicate a value of two in the first UCI. The second UCI may indicate beam indexes and L1 metrics for the reported beam groups. For example, the UE may report the two beam groups that are identified and corresponding L1-RSRP values in the second UCI.

In some aspects, the first UCI may indicate a fixed number of beam groups reported in the CSI report and a number of remaining beam groups reported in the CSI report. The first UCI may indicate one or more CRIs, one or more SSBRIs, a CMR set indicator, an RSRP value, one or more differential RSRP values, and/or the number of remaining beam groups reported in the CSI report. The second UCI may indicate beam indexes and L1 metrics for the number of remaining beam groups reported in the CSI report. The second UCI may indicate one or more CRIs associated with the number of remaining beam groups reported in the CSI report, one or more SSBRIs associated with the number of remaining beam groups reported in the CSI report, and/or one or more differential RSRP values associated with the number of remaining beam groups reported in the CSI report.

In some aspects, when the UE reports the UCI of two parts, the first UCI may indicate the fixed number of beam groups reported in the CSI report, and the number of remaining beam groups to be actually reported in the CSI report. For example, the CSI report may configure the UE to report up to four beam groups, but the UE may identify and report only three beam groups. In this example, the UE may report a first group of beams and corresponding L1-RSRPs in the first UCI, and the UE may also report a value of two in the first UCI. The value of two in the first UCI may correspond to the remaining beam groups to be actually reported in the CSI report. The second UCI may indicate beam indexes and L1 metrics for the remaining beam groups. For example, the UE may report a second group of beams and a third group of beams and corresponding L1-RSRPs in the second UCI.

In some aspects, for CSI omission purposes, when multiple CSI reports are scheduled in a same UCI transmission occasion, the UE may determine a priority for the enhanced group-based beam report. In other words, the UE may transmit the CSI report in accordance with a CSI priority based at least in part on the multiple CSI reports being scheduled in the same UCI transmission occasion. In some aspects, the UE may determine the priority based at least in part on the CSI priority. The CSI priority for the enhanced group-based beam report may be the same as or lower than for a group-based beam report. In some aspects, when the multiple CSI reports are scheduled in the same UCI transmission occasion, the UE may determine the priority for the UCI of two parts (or a two-part enhanced group-based beam report) based at least in part on the CSI priority. The CSI priority may be the same as or lower than for a single-part group-based beam report. In other words, the CSI priority may be relative to the single-part group-based beam report.

As indicated above, FIG. 3 is provided as an example. Other examples may differ from what is described with regard to FIG. 3.

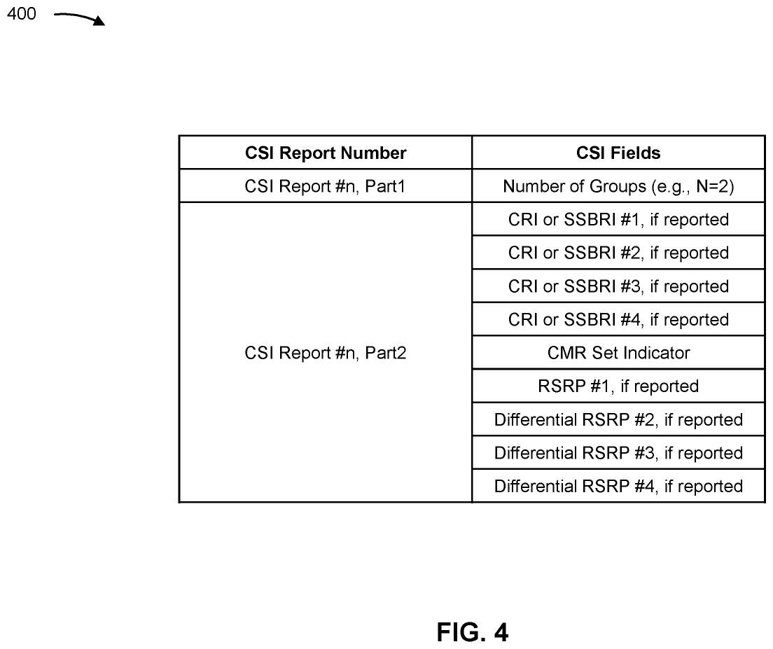

FIG. 4 is a diagram illustrating an example 400 associated with transmitting two-part UCI for group-based beam reporting, in accordance with the present disclosure.

As shown in FIG. 4, when a UE reports a UCI (or CSI report) of two parts, a first UCI may indicate a number of beam groups (N) actually reported in the CSI report. For example, the first UCI may indicate that Nis equal to two. A second UCI may indicate beam indexes and L1 metrics for reported beam groups. For example, the second UCI may indicate a CRI or SSBRI #1 (if reported), a CRI or SSBRI #2 (if reported), a CRI or SSBRI #3 (if reported), a CRI or SSBRI #4 (if reported), a CMR set indicator, an RSRP #1 (if reported), a differential RSRP #2 (if reported), a differential RSRP #3 (if reported), and a differential RSRP #4 (if reported).

As indicated above, FIG. 4 is provided as an example. Other examples may differ from what is described with regard to FIG. 4.

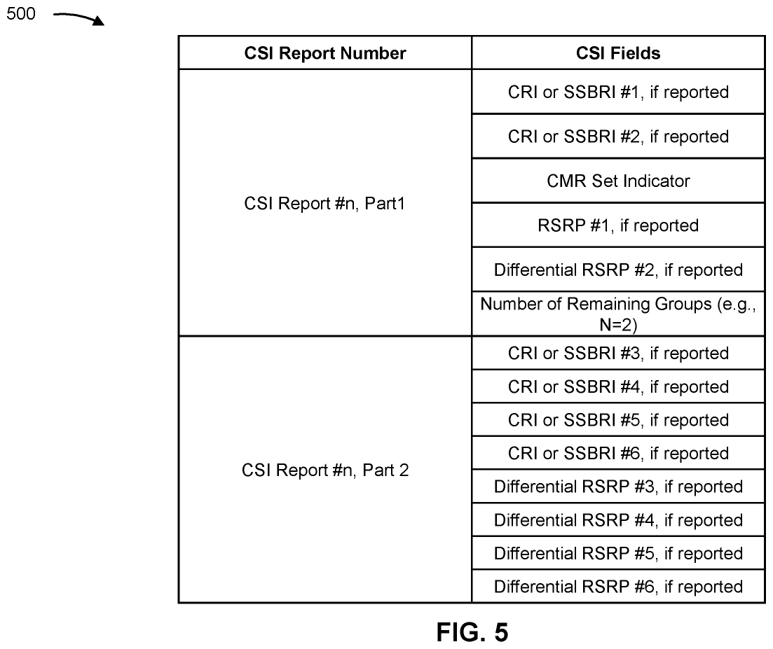

FIG. 5 is a diagram illustrating an example 500 associated with transmitting two-part UCI for group-based beam reporting, in accordance with the present disclosure.

As shown in FIG. 5, when a UE reports a UCI (or CSI report) of two parts, a first UCI may indicate a fixed number of beam groups reported in the CSI report. For example, the first UCI may indicate a CRI or SSBRI #1 (if reported), a CRI or SSBRI #2 (if reported), a CMR set indicator, an RSRP #1 (if reported), and a differential RSRP #2 (if reported). Further, the first UCI may indicate a number of remaining beam groups (N) to be actually reported in the CSI report. For example, the first UCI may indicate that N is equal to two, which may correspond to two remaining beam groups to be actually reported in the CSI report. The second UCI may indicate, based at least in part on the number of remaining beam groups indicated in the first UCI, a CRI or SSBRI #3 (if reported), a CRI or SSBRI #4 (if reported), a CRI or SSBRI #5 (if reported), a CRI or SSBRI #6 (if reported), a differential RSRP #3 (if reported), a differential RSRP #4 (if reported), and a differential RSRP #5 (if reported), and a differential RSRP #6 (if reported).

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with techniques for transmitting two-part UCI for group-based beam reporting.

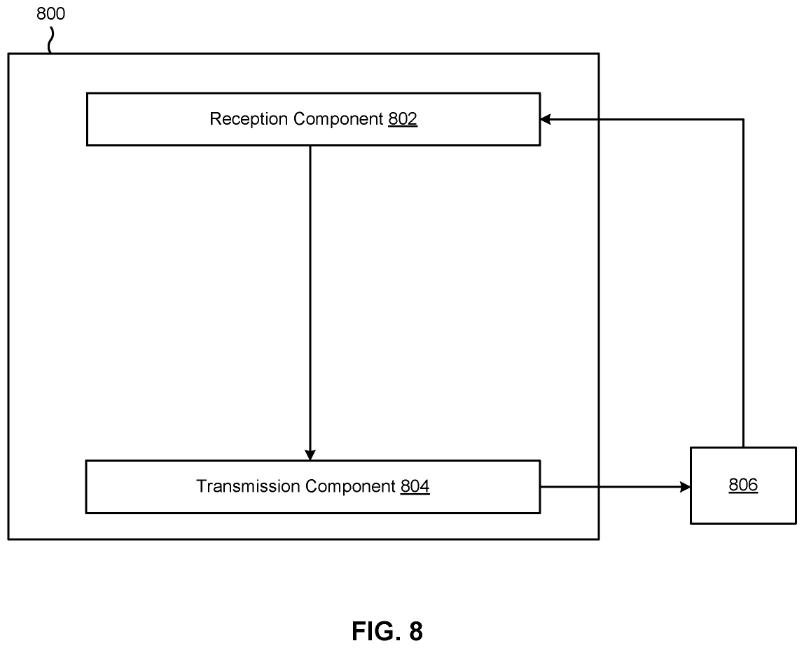

As shown in FIG. 6, in some aspects, process 600 may include receiving, from a base station associated with multiple transmit-receive points, a plurality of reference signals associated with a plurality of beam groups (block 610). For example, the UE (e.g., using reception component 802, depicted in FIG. 8) may receive, from a base station associated with multiple transmit-receive points, a plurality of reference signals associated with a plurality of beam groups, as described above.

As further shown in FIG. 6, in some aspects, process 600 may include transmitting, to the base station, a CSI report that includes a group-based beam report indicating beam measurements associated with the plurality of reference signals, wherein the CSI report includes a first UCI and a second UCI that is transmitted separately from the first UCI (block 620). For example, the UE (e.g., using transmission component 804, depicted in FIG. 8) may transmit, to the base station, a CSI report that includes a group-based beam report indicating beam measurements associated with the plurality of reference signals, wherein the CSI report includes a first UCI and a second UCI that is transmitted separately from the first UCI, as described above.

Process 600 may include additional aspects, such as any single aspect or any combination of aspects described below and/or in connection with one or more other processes described elsewhere herein.

In a first aspect, the CSI report includes the first UCI and the second UCI based at least in part on a maximum number of beam groups configured in a CSI report configuration received from the base station.

In a second aspect, alone or in combination with the first aspect, the CSI report includes the first UCI and the second UCI based at least in part on a dedicated RRC indication received from the base station, wherein the dedicated RRC indication indicates a two-part UCI.

In a third aspect, alone or in combination with one or more of the first and second aspects, the first UCI is transmitted in an entirety before the second UCI is transmitted.

In a fourth aspect, alone or in combination with one or more of the first through third aspects, the CSI report is transmitted in a PUCCH or in a PUSCH.

In a fifth aspect, alone or in combination with one or more of the first through fourth aspects, the first UCI indicates a number of beam groups reported in the CSI report, and the second UCI indicates beam indexes and L1 metrics for reported beam groups.

In a sixth aspect, alone or in combination with one or more of the first through fifth aspects, the beam indexes and L1 metrics include one or more of one or more CRIs, one or more SSBRIs, a CMR set indicator, an RSRP value, or one or more differential RSRP values.

In a seventh aspect, alone or in combination with one or more of the first through sixth aspects, the first UCI indicates a fixed number of beam groups reported in the CSI report and a number of remaining beam groups reported in the CSI report, and the second UCI indicates beam indexes and L1 metrics for the number of remaining beam groups reported in the CSI report.

In an eighth aspect, alone or in combination with one or more of the first through seventh aspects, the first UCI indicates one or more of one or more CRIs, one or more SSBRIs, a CMR set indicator, an RSRP value, one or more differential RSRP values, or the number of remaining beam groups reported in the CSI report, and the second UCI indicates one or more of one or more CRIs associated with the number of remaining beam groups reported in the CSI report, one or more SSBRIs associated with the number of remaining beam groups reported in the CSI report, or one or more differential RSRP values associated with the number of remaining beam groups reported in the CSI report.

In a ninth aspect, alone or in combination with one or more of the first through eighth aspects, the CSI report is transmitted in accordance with a CSI priority based at least in part on multiple CSI reports being scheduled in a same UCI transmission occasion, wherein the CSI priority is relative to a single-part group-based beam report.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with techniques for transmitting two-part UCI for group-based beam reporting.

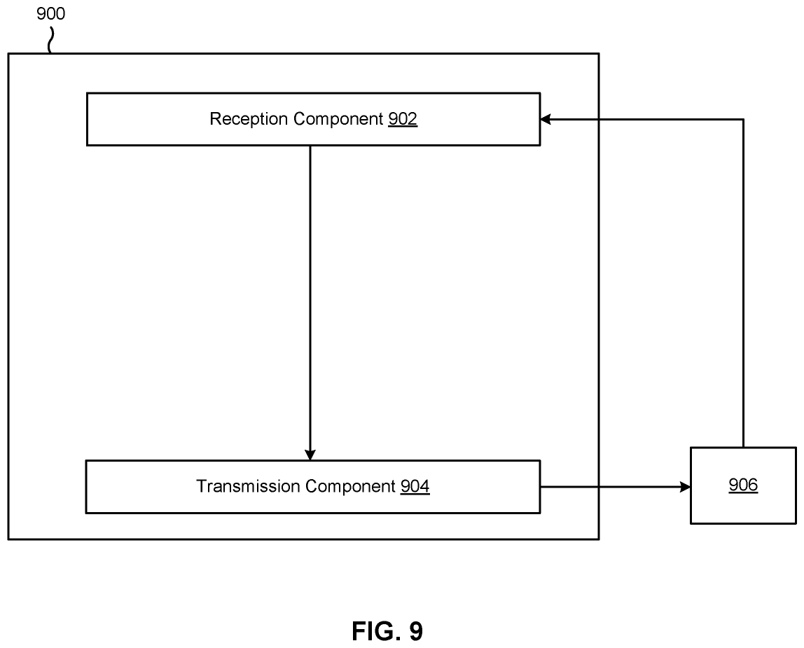

As shown in FIG. 7, in some aspects, process 700 may include transmitting, to a UE, a plurality of reference signals associated with a plurality of beam groups (block 710). For example, the base station (e.g., using transmission component 904, depicted in FIG. 9) may transmit, to a UE, a plurality of reference signals associated with a plurality of beam groups, as described above.

As further shown in FIG. 7, in some aspects, process 700 may include receiving, from the UE, a CSI report that includes a group-based beam report indicating beam measurements associated with the plurality of reference signals, the CSI report includes a first UCI and a second UCI that is received separately from the first UCI (block 720). For example, the base station (e.g., using reception component 902, depicted in FIG. 9) may receive, from the UE, a CSI report that includes a group-based beam report indicating beam measurements associated with the plurality of reference signals, wherein the CSI report includes a first UCI and a second UCI that is received separately from the first UCI, as described above.

Process 700 may include additional aspects, such as any single aspect or any combination of aspects described below and/or in connection with one or more other processes described elsewhere herein.

In a first aspect, the CSI report includes the first UCI and the second UCI based at least in part on a maximum number of beam groups configured in a CSI report configuration received from the base station.

In a second aspect, alone or in combination with the first aspect, the CSI report includes the first UCI and the second UCI based at least in part on a dedicated RRC indication received from the base station, wherein the dedicated RRC indication indicates a two-part UCI.

In a third aspect, alone or in combination with one or more of the first and second aspects, the first UCI is received in an entirety before the second UCI is received.

In a fourth aspect, alone or in combination with one or more of the first through third aspects, the CSI report is received in a PUCCH or in a PUSCH.

In a fifth aspect, alone or in combination with one or more of the first through fourth aspects, the first UCI indicates a number of beam groups reported in the CSI report, and the second UCI indicates beam indexes and L1 metrics for reported beam groups.

In a sixth aspect, alone or in combination with one or more of the first through fifth aspects, the beam indexes and L1 metrics include one or more of one or more CRIs, one or more SSBRIs, a CMR set indicator, an RSRP value, or one or more differential RSRP values.

In a seventh aspect, alone or in combination with one or more of the first through sixth aspects, the first UCI indicates a fixed number of beam groups reported in the CSI report and a number of remaining beam groups reported in the CSI report, and the second UCI indicates beam indexes and L1 metrics for the number of remaining beam groups reported in the CSI report.

In an eighth aspect, alone or in combination with one or more of the first through seventh aspects, the first UCI indicates one or more of one or more CRIs, one or more SSBRIs, a CMR set indicator, an RSRP value, one or more differential RSRP values, or the number of remaining beam groups reported in the CSI report, and the second UCI indicates one or more of one or more CRIs associated with the number of remaining beam groups reported in the CSI report, one or more SSBRIs associated with the number of remaining beam groups reported in the CSI report, or one or more differential RSRP values associated with the number of remaining beam groups reported in the CSI report.

In a ninth aspect, alone or in combination with one or more of the first through eighth aspects, the CSI report is received in accordance with a CSI priority based at least in part on multiple CSI reports being scheduled in a same UCI transmission occasion, wherein the CSI priority is relative to a single-part group-based beam report.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804.

In some aspects, the apparatus 800 may be configured to perform one or more operations described herein in connection with FIGS. 3-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive, from a base station associated with multiple transmit-receive points, a plurality of reference signals associated with a plurality of beam groups. The transmission component 804 may transmit, to the base station, a CSI report that includes a group-based beam report indicating beam measurements associated with the plurality of reference signals, wherein the CSI report includes a first UCI and a second UCI that is transmitted separately from the first UCI.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904.

In some aspects, the apparatus 900 may be configured to perform one or more operations described herein in connection with FIGS. 3-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The transmission component 904 may transmit, to a UE, a plurality of reference signals associated with a plurality of beam groups. The reception component 902 may receive, from the UE, a CSI report that includes a group-based beam report indicating beam measurements associated with the plurality of reference signals, wherein the CSI report includes a first UCI and a second UCI that is received separately from the first UCI.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving, from a base station associated with multiple transmit-receive points, a plurality of reference signals associated with a plurality of beam groups; and transmitting, to the base station, a channel state information (CSI) report that includes a group-based beam report indicating beam measurements associated with the plurality of reference signals, wherein the CSI report includes a first uplink control information (UCI) and a second UCI that is transmitted separately from the first UCI.

Aspect 2: The method of Aspect 1, wherein the CSI report includes the first UCI and the second UCI based at least in part on a maximum number of beam groups configured in a CSI report configuration received from the base station.

Aspect 3: The method of any of Aspects 1 through 2, wherein the CSI report includes the first UCI and the second UCI based at least in part on a dedicated radio resource control (RRC) indication received from the base station, wherein the dedicated RRC indication indicates a two-part UCI.

Aspect 4: The method of any of Aspects 1 through 3, wherein the first UCI is transmitted in an entirety before the second UCI is transmitted.

Aspect 5: The method of any of Aspects 1 through 4, wherein the CSI report is transmitted in a physical uplink control channel or in a physical uplink shared channel.

Aspect 6: The method of any of Aspects 1 through 5, wherein: the first UCI indicates a number of beam groups reported in the CSI report: and the second UCI indicates beam indexes and layer 1 (L1) metrics for reported beam groups.

Aspect 7: The method of Aspect 6, wherein the beam indexes and L1 metrics include one or more of: one or more channel state information reference signal resource indicators, one or more synchronization signal or physical broadcast channel resource indicators, a channel measurement resource set indicator, a reference signal received power (RSRP) value, or one or more differential RSRP values.

Aspect 8: The method of any of Aspects 1 through 7, wherein: the first UCI indicates a fixed number of beam groups reported in the CSI report and a number of remaining beam groups reported in the CSI report; and the second UCI indicates beam indexes and layer 1 (L1) metrics for the number of remaining beam groups reported in the CSI report.

Aspect 9: The method of Aspect 8, wherein: the first UCI indicates one or more of: one or more channel state information reference signal resource indicators (CRIs), one or more synchronization signal or physical broadcast channel resource indicators (SSBRIs), a channel measurement resource set indicator, a reference signal received power (RSRP) value, one or more differential RSRP values, or the number of remaining beam groups reported in the CSI report; and the second UCI indicates one or more of: one or more CRIs associated with the number of remaining beam groups reported in the CSI report, one or more SSBRIs associated with the number of remaining beam groups reported in the CSI report, or one or more differential RSRP values associated with the number of remaining beam groups reported in the CSI report.

Aspect 10: The method of any of Aspects 1 through 9, wherein the CSI report is transmitted in accordance with a CSI priority based at least in part on multiple CSI reports being scheduled in a same UCI transmission occasion, wherein the CSI priority is relative to a single-part group-based beam report.

Aspect 11: A method of wireless communication performed by a base station, comprising: transmitting, to a user equipment (UE), a plurality of reference signals associated with a plurality of beam groups; and receiving, from the UE, a channel state information (CSI) report that includes a group-based beam report indicating beam measurements associated with the plurality of reference signals, wherein the CSI report includes a first uplink control information (UCI) and a second UCI that is received separately from the first UCI.

Aspect 12: The method of Aspect 11, wherein the CSI report includes the first UCI and the second UCI based at least in part on a maximum number of beam groups configured in a CSI report configuration received from the base station.

Aspect 13: The method of any of Aspects 11 through 12, wherein the CSI report includes the first UCI and the second UCI based at least in part on a dedicated radio resource control (RRC) indication received from the base station, wherein the dedicated RRC indication indicates a two-part UCI.

Aspect 14: The method of any of Aspects 11 through 13, wherein the first UCI is received in an entirety before the second UCI is received.

Aspect 15: The method of any of Aspects 11 through 14, wherein the CSI report is received in a physical uplink control channel or in a physical uplink shared channel.

Aspect 16: The method of any of Aspects 11 through 15, wherein: the first UCI indicates a number of beam groups reported in the CSI report; and the second UCI indicates beam indexes and layer 1 (L1) metrics for reported beam groups.

Aspect 17: The method of Aspect 16, wherein the beam indexes and LI metrics include one or more of: one or more channel state information reference signal resource indicators, one or more synchronization signal or physical broadcast channel resource indicators, a channel measurement resource set indicator, a reference signal received power (RSRP) value, or one or more differential RSRP values.

Aspect 18: The method of any of Aspects 11 through 17, wherein: the first UCI indicates a fixed number of beam groups reported in the CSI report and a number of remaining beam groups reported in the CSI report; and the second UCI indicates beam indexes and layer 1 (L1) metrics for the number of remaining beam groups reported in the CSI report.

Aspect 19: The method of Aspect 18, wherein: the first UCI indicates one or more of: one or more channel state information reference signal resource indicators (CRIs), one or more synchronization signal or physical broadcast channel resource indicators (SSBRIs), a channel measurement resource set indicator, a reference signal received power (RSRP) value, one or more differential RSRP values, or the number of remaining beam groups reported in the CSI report; and the second UCI indicates one or more of: one or more CRIs associated with the number of remaining beam groups reported in the CSI report, one or more SSBRIs associated with the number of remaining beam groups reported in the CSI report, or one or more differential RSRP values associated with the number of remaining beam groups reported in the CSI report.

Aspect 20: The method of any of Aspects 11 through 19, wherein the CSI report is received in accordance with a CSI priority based at least in part on multiple CSI reports being scheduled in a same UCI transmission occasion, wherein the CSI priority is relative to a single-part group-based beam report.

Aspect 21: An apparatus for wireless communication at a device, comprising a processor: memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a base station associated with multiple transmit-receive points, a plurality of reference signals associated with a plurality of beam groups; and
transmitting, to the base station, a channel state information (CSI) report that includes a group-based beam report indicating beam measurements associated with the plurality of reference signals, wherein the CSI report includes a first uplink control information (UCI) and a second UCI that is transmitted separately from the first UCI.

2. The method of claim 1, wherein the CSI report includes the first UCI and the second UCI based at least in part on a maximum number of beam groups configured in a CSI report configuration received from the base station.

3. The method of claim 1, wherein the CSI report includes the first UCI and the second UCI based at least in part on a dedicated radio resource control (RRC) indication received from the base station, wherein the dedicated RRC indication indicates a two-part UCI.

4. The method of claim 1, wherein the first UCI is transmitted in an entirety before the second UCI is transmitted.

5. The method of claim 1, wherein the CSI report is transmitted in a physical uplink control channel or in a physical uplink shared channel.

6. The method of claim 1, wherein:
the first UCI indicates a number of beam groups reported in the CSI report; and
the second UCI indicates beam indexes and layer 1 (LI) metrics for reported beam groups.

7. The method of claim 6, wherein the beam indexes and L1 metrics include one or more of: one or more channel state information reference signal resource indicators, one or more synchronization signal or physical broadcast channel resource indicators, a channel measurement resource set indicator, a reference signal received power (RSRP) value, or one or more differential RSRP values.

8. The method of claim 1, wherein:
the first UCI indicates a fixed number of beam groups reported in the CSI report and a number of remaining beam groups reported in the CSI report; and
the second UCI indicates beam indexes and layer 1 (L1) metrics for the number of remaining beam groups reported in the CSI report.

9. The method of claim 8, wherein:
the first UCI indicates one or more of: one or more channel state information reference signal resource indicators (CRIs), one or more synchronization signal or physical broadcast channel resource indicators (SSBRIs), a channel measurement resource set indicator, a reference signal received power (RSRP) value, one or more differential RSRP values, or the number of remaining beam groups reported in the CSI report; and
the second UCI indicates one or more of: one or more CRIs associated with the number of remaining beam groups reported in the CSI report, one or more SSBRIs associated with the number of remaining beam groups reported in the CSI report, or one or more differential RSRP values associated with the number of remaining beam groups reported in the CSI report.

10. The method of claim 1, wherein the CSI report is transmitted in accordance with a CSI priority based at least in part on multiple CSI reports being scheduled in a same UCI transmission occasion, wherein the CSI priority is relative to a single-part group-based beam report.

11. A method of wireless communication performed by a base station, comprising:
transmitting, to a user equipment (UE), a plurality of reference signals associated with a plurality of beam groups; and
receiving, from the UE, a channel state information (CSI) report that includes a group-based beam report indicating beam measurements associated with the plurality of reference signals, wherein the CSI report includes a first uplink control information (UCI) and a second UCI that is received separately from the first UCI.

12. The method of claim 11, wherein the CSI report includes the first UCI and the second UCI based at least in part on a maximum number of beam groups configured in a CSI report configuration received from the base station.

13. The method of claim 11, wherein the CSI report includes the first UCI and the second UCI based at least in part on a dedicated radio resource control (RRC) indication received from the base station, wherein the dedicated RRC indication indicates a two-part UCI.

14. The method of claim 11, wherein the first UCI is received in an entirety before the second UCI is received.

15. The method of claim 11, wherein the CSI report is received in a physical uplink control channel or in a physical uplink shared channel.

16. The method of claim 11, wherein:
the first UCI indicates a number of beam groups reported in the CSI report; and the second UCI indicates beam indexes and layer 1 (L1) metrics for reported beam groups.

17. The method of claim 16, wherein the beam indexes and L1 metrics include one or more of: one or more channel state information reference signal resource indicators, one or more synchronization signal or physical broadcast channel resource indicators, a channel measurement resource set indicator, a reference signal received power (RSRP) value, or one or more differential RSRP values.

18. The method of claim 11, wherein:
the first UCI indicates a fixed number of beam groups reported in the CSI report and a number of remaining beam groups reported in the CSI report; and
the second UCI indicates beam indexes and layer 1 (L1) metrics for the number of remaining beam groups reported in the CSI report.

19. The method of claim 18, wherein:
the first UCI indicates one or more of: one or more channel state information reference signal resource indicators (CRIs), one or more synchronization signal or physical broadcast channel resource indicators (SSBRIs), a channel measurement resource set indicator, a reference signal received power (RSRP) value, one or more differential RSRP values, or the number of remaining beam groups reported in the CSI report; and
the second UCI indicates one or more of: one or more CRIs associated with the number of remaining beam groups reported in the CSI report, one or more SSBRIs associated with the number of remaining beam groups reported in the CSI report, or one or more differential RSRP values associated with the number of remaining beam groups reported in the CSI report.

20. The method of claim 11, wherein the CSI report is received in accordance with a CSI priority based at least in part on multiple CSI reports being scheduled in a same UCI transmission occasion, wherein the CSI priority is relative to a single-part group-based beam report.

21. An apparatus for wireless communication at a user equipment (UE), comprising:
a memory; and
one or more processors, coupled to the memory, configured to:
receive, from a base station associated with multiple transmit-receive points, a plurality of reference signals associated with a plurality of beam groups; and
transmit, to the base station, a channel state information (CSI) report that includes a group-based beam report indicating beam measurements associated with the plurality of reference signals, wherein the CSI report includes a first uplink control information (UCI) and a second UCI that is transmitted separately from the first UCI.

22. The apparatus of claim 21, wherein:
the CSI report includes the first UCI and the second UCI based at least in part on a maximum number of beam groups configured in a CSI report configuration received from the base station; or
the CSI report includes the first UCI and the second UCI based at least in part on a dedicated radio resource control (RRC) indication received from the base station, wherein the dedicated RRC indication indicates a two-part UCI.

23. The apparatus of claim 21, wherein the one or more processors, to transmit the CSI report that includes the first UCI and the second UCI, are configured to transmit the first UCI in an entirety before the second UCI is transmitted.

24. The apparatus of claim 21, wherein:
the first UCI indicates a number of beam groups reported in the CSI report; and
the second UCI indicates beam indexes and layer 1 (L1) metrics for reported beam groups.

25. The apparatus of claim 21, wherein:
the first UCI indicates a fixed number of beam groups reported in the CSI report and a number of remaining beam groups reported in the CSI report; and
the second UCI indicates beam indexes and layer 1 (L1) metrics for the number of remaining beam groups reported in the CSI report.

26. An apparatus for wireless communication at a base station, comprising:
a memory; and
one or more processors, coupled to the memory, configured to:
transmit, to a user equipment (UE), a plurality of reference signals associated with a plurality of beam groups; and
receive, from the UE, a channel state information (CSI) report that includes a group-based beam report indicating beam measurements associated with the plurality of reference signals, wherein the CSI report includes a first uplink control information (UCI) and a second UCI that is received separately from the first UCI.

27. The apparatus of claim 26, wherein:
the CSI report includes the first UCI and the second UCI based at least in part on a maximum number of beam groups configured in a CSI report configuration received from the base station; or
the CSI report includes the first UCI and the second UCI based at least in part on a dedicated radio resource control (RRC) indication received from the base station, wherein the dedicated RRC indication indicates a two-part UCI.

28. The apparatus of claim 26, wherein the one or more processors, to receive the CSI report that includes the first UCI and the second UCI, are configured to receive the first UCI in an entirety before the second UCI is transmitted.

29. The apparatus of claim 26, wherein:
the first UCI indicates a number of beam groups reported in the CSI report; and
the second UCI indicates beam indexes and layer 1 (L1) metrics for reported beam groups.

30. The apparatus of claim 26, wherein:
the first UCI indicates a fixed number of beam groups reported in the CSI report and a number of remaining beam groups reported in the CSI report; and
the second UCI indicates beam indexes and layer 1 (L1) metrics for the number of remaining beam groups reported in the CSI report.
